(19) United States
(12) Patent Application Publication
(10) Pub. No.: US 2001/0045721 A1
(43) Pub. Date: Nov. 29, 2001

(54) Shock absorbing fork and bicycle, motorcycle or tricycle with such a shock absorbing fork

(75) Inventor: Richard Heydenreich, Neubiberg (DE)

Correspondence Address: SUGHRUE, MION, ZINN, MACPEAK & SEAS, 2100 Pennsylvania Avenue, N.W. Suite 800, Washington, DC, 20037-3202, US

(73) Assignee: UNIVEGA BIKES & SPORTS EUROPE GMBH

(21) Appl. No.: 09/899,076

(22) Filed: Jul. 6, 2001

Related U.S. Application Data
(63) Continuation of application No. PCT/EP00/00085, filed on Jan. 7, 2000.

(30) Foreign Application Priority Data
Jan. 8, 1999 (DE) 199 00 416.1

(51) Int. Cl. B62K 21/02; B62K 25/04

(52) U.S. Cl. 280/276

(57) ABSTRACT

A shock absorbing fork comprises a central shock absorbing means accommodated in the steering head (5) of a two-wheeler frame, a splined or polygonal fork stanchion tube (1) being guided non-rotatably in a correspondingly shaped bearing bush (2), said bearing bush (2) itself being non-rotatably mounted in a guide tube (3) rotatably mounted in tie steering head (5), and wherein the bearing bush (2) is elastic and radially contractible, permitting readjustment of the play.

### TECHNICAL FIELD

The invention relates to a shock absorbing or suspension fork according to the preamble of patent claim 1 as well as to a bicycle, motorcycle, tricycle or like vehicle provided with the shock absorbing fork in accordance with the invention. The invention particularly relates to a shock absorbing fork, the deflection of which takes place within the so-called steering head, and which has a novel variable-play bearing arrangement.

### STATE OF THE ART

For two-wheelers of various types, so-called telescopic suspension forks are known from prior art in which the front wheel is supported in two parallel telescopic guides. The telescopic guides are themselves connected by means of at least one so-called fork bridge to the steering spindle.

Also known from prior art are shock absorbing forks in which a central telescopic guide is arranged within the frame steering head. In this case, appropriate measures must be taken to ensure that the deflection and the desired rotational movement upon steering can ensue independently of each other. The last mentioned structural design has advantages in terms of torsional stiffness, weight and a harmonious appearance which is typical of bicycles. However, for fully satisfactory operation, zero-play transmission of the steering movement to the front wheel is imperative.

A solution for this is known from prior art in which a polygonal fork stanchion is guided by rolling bearings to be longitudinal moveable. The guides can be adjusted to be free of play. However, such an embodiment is comparatively heavy, expensive, maintenance-intensive and requires a high production outlay.

A further known solution provides for a splined fork stanchion which is guided in an equally splined plastic bearing bush. The production outlay for this is lower. However, zero play can be ensured only to a limited extent during manufacture and, in particular, even less so as a result of wear.

A shock absorbing fork according to the preamble of patent claim 1 is known from DE-OS-15 05 232 and has a splined fork stanchion tube which is non-rotatably guided in a correspondingly shaped bearing bush. The bearing bush itself is mounted non-rotatably in a guide tube rotatably mounted in the steering head. On account of this arrangement, as revealed above, a zero-play arrangement cannot be reliably guaranteed and, in particular, cannot be subsequently readjusted.

U.S. Pat. No. 5,509,676 discloses an adjustable frictional damper in which axial bias of an elastic ring is adjusted by means of a bias sleeve so that the wall friction with regard to the fork stanchion tube is increased.

### SUMMARY OF THE INVENTION

The invention is based on the objective of providing a shock absorbing fork in which, over a long period of time, the play can be adjusted and readjusted and which ensures satisfactory shock absorbing comfort for low production and maintenance outlay.

This objective is achieved by means of the features of patent claim 1.

Accordingly, in accordance with the invention, the bearing bush in which the fork stanchion tube is mounted, is elastic. Additionally, the bearing bush is radially contractible, on account of which the play is variable, i.e. adjustable and readjustable. On account of these measures, on the one hand, a bearing bush can be used which is manufacturable with a relatively low manufacturing outlay and, additionally, requiring little maintenance. As a result of is, good guidance of the components of the shock absorbing fork is always assured. Due to the bearing bush of the shock absorbing fork in accordance with the invention also being radially contractible, for example, after wear has occurred between components guided within each other, which leads to undesirable play, this can be radially reduced by appropriate means so that the play can be readjusted. In particular, the elastic and radially contractible bearing bush can be contracted in such a manner that a zero-play mounting is provided even after wear has ensued. In this case, there is no requirement for an excessively enlarged structural space as compared to known arrangements so that the shock absorbing fork in accordance with the invention can also offer advantages in this respect.

Preferred further developments are described in the additional claims.

According to a first preferred embodiment of the invention, contracting the bearing bush radially is achievable by the bearing bush being mounted in the guide tube by means of a conical bearing seat. Further, a thrust ring or similar component is provided which displaces the bearing bush axially. Due to the elastic bearing bush being displaced in the direction of the smaller diameter of the conical bearing seat, the bearing bush is radially contracted and the play can be readjusted.

According to a further preferred embodiment the bearing bush can be substantially cylindrical and is radially contractible by means of a thrust ring provided with an inner cone. In this arrangement the thrust ring provided with the inner cone acts preferably on a slotted guide tube. Also in this embodiment, being able to readjust the play in accordance with the invention is assured by simple design.

A further development of the invention has also proved to be advantageous in which a slotted guide tube is provided upon which a clamping collar or clamping band acts. Since the bearing bush is mounted non-rotatably in the guide tube, it is thus radially contracted by the radial contraction of the guide tube and, in accordance with the invention, the play can be readjusted to the desired degree.

In configuring a shock absorbing fork provided overall with good spring and damping characteristics, it is also preferred in accordance with the invention that an upper guide bearing is formed on the fork stanchion tube to be elastic or complemented by an elastic ring which can be axially biased at different applied forces. This varies the wall friction with respect to the fork stanchion tube to permit adjusting the damping effect produced.

In this case, one embodiment has proved to be favourable in which a relatively stiff guide bush ensures the precise central location of the fork stanchion tube and, therefore, prevents canting. An additional, relatively soft elastic ring, which is more or less axially biased, then handles precisely reducing the play and/or adjusting tie damping which can be controlled and set, for example, by a biasing sleeve set externally and provided with detents. The biasing sleeve is preferably set externally by means of a thread.

For setting the previously described damping effect, it is additionally of advantage if a supplementary pneumatic shock absorption is provided in the upper guide bearing which influences biasing of the elastic ring and, thus, the damping properties.

Finally, a particularly favourable damping effect can be achieved be providing a hydraulic oscillation damper in addition to, or instead of, the elastic ring in the upper guide bearing.

Preferably, at least one of the partners involved in frictional engagement particularly guide parts moving with respect to each other, is coated with a friction-reducing coating. Thus, the relative movement between the mentioned components can ensue unhindered, and guidance with zero play and relatively low friction is achieved.

According to a further aspect of the invention, a bicycle, a motorcycle, a tricycle or like vehicle is provided which comprises the shock absorbing fork according to one of the previously described embodiments of the invention, in achieving advantageous and adjustable shock absorption with zero play for the respective vehicle.

### BRIEF DESCRIPTION OF THE DRAWINGS

In the following, the invention will be described in more detail with reference by way of example to embodiments shown in the drawings, in which,

FIG. 1 is a cross section through the steering head of a bicycle which is equipped with the shock absorbing fork according to a first embodiment of the invention;

FIG. 2 is a cross section through the steering head of a bicycle which is equipped with the shock absorbing fork according to a second embodiment of the invention;

FIG. 3 is a cross section through the steering head of a bicycle which is equipped with the shock absorbing fork according to a third embodiment of the invention;

FIG. 4 is a cross section through the steering head of a bicycle which is equipped with the shock absorbing fork according to a further development of the first embodiment of the invention; and

FIG. 5 is a cross section through the steering head of a bicycle which is equipped with the shock absorbing fork according to a second further development of the first embodiment of the invention.

### DETAILED DESCRIPTION OF PREFERRED EMBODIMENTS OF THE INVENTION

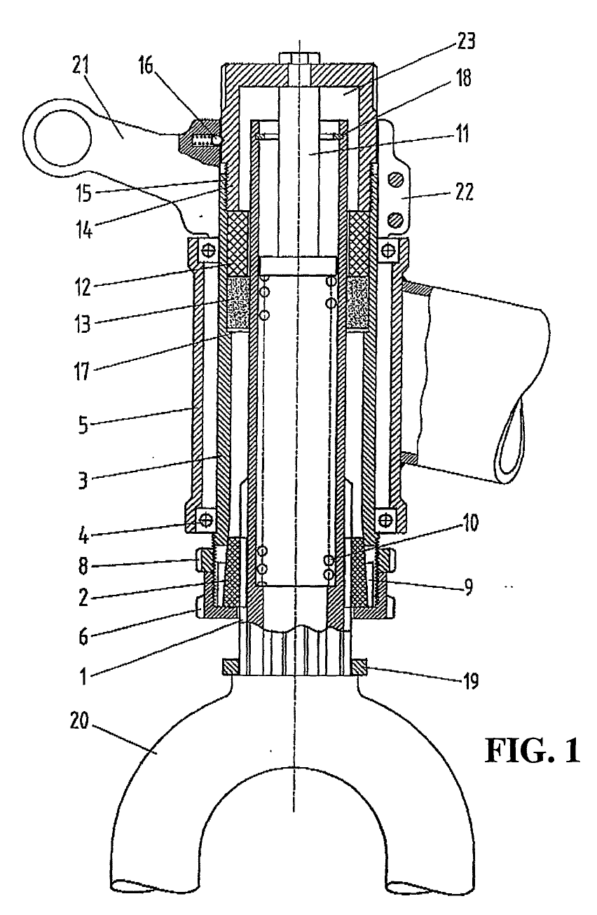

As shown in FIG. 1, the shock absorbing fork in accordance with the invention is in part a known so-called “central spring fork” in which a so-called guiding tube 3, which may be configured slotted, is mounted by means of roller bearings 4 in a steering head 5 formed on the frame of a bicycle. A bearing bush 2 sits non-rotatably in the guide tube 3, in the illustrated case, by means of so-called guide lugs 9.

Non-rotatably guided in the longitudinal direction in the the bush 2 is a fork stanchion tube 1 which is polygonal or in the form of a splined stanchion. The bearing bush 2 can advantageously consist of a plastic injection-molded part for smooth, quiet cooperation with the fork stanchion tube 1 even when insufficiently lubricated. However, it is principally of disadvantage in this case on account of the totality of the unavoidable finishing tolerances and a continuously occurring wear that an inaccurate and insensitive steering can occur.

Consequently, the bearing bush 2 of the shock-absorbing fork in accordance with the invention is radially contractible. For this purpose, on the one hand, it is elastic. On the other hand, in the illustrated embodiment, it is conically formed and, consequently, mounted in the guide tube 3 by means of a conical bearing seat provided at the outer periphery of the bush. On account of an axial displacement of the bearing bush 2 upwardly in accordance with FIG. 1, namely “further” into the guide tube 3, the bearing bush 2 is radially contracted and the play can be precisely set and eliminated as much as desired. Such an adjustment is possible up to a bias at which an oscillation damping is effected. Axial displacement of the bearing bush 2 materializes in the illustrated exemplary embodiment by means of a so-called thrust ring 6 which is screwed onto the guide tube 3 by means of a thread. Preferably, the thrust ring is provided with a fine thread and, in the illustrated exemplary embodiment, can be fixed in any desired position by means of the lock nut 8 for achieving adjustment and readjustment of the play in accordance with the invention.

In the illustrated embodiment, the support and shock absorption of the road forces ensues by means of a spring 10 preferably made of steel or, alternatively, by means of an elastomer, against the upper spring bearing 11. The spring and damping characteristics of the shock-absorbing fork in accordance with the invention are supplemented in an advantageous manner in that the upper guide is formed of a combination of a cylindrical guide bush 12 and an elastic ring 13. In this area it is also applicable that, as in the case of the previously described lower guide, injection moulded or cast plastic bushes have a comparatively large finishing tolerance. The deformable second guide ring 13 serves for the adjustment of play in this area. The elastic ring 13 is supported downwards by means of a ring 17 mounted on a shoulder of the guide tube 3.

Axial biasing permits varying the inner diameter of the elastic ring 13 to a certain extent in thus enabling play and wall friction, which additionally effects damping, to be varied as desired. In the illustrated case, this is effected by a pressure sleeve 14. In order to prevent unintentional displacement of this pressure sleeve 14, it is secured against undesirable rotation either by means of a detent 16 or by clamping by means of the handlebar projection 22.

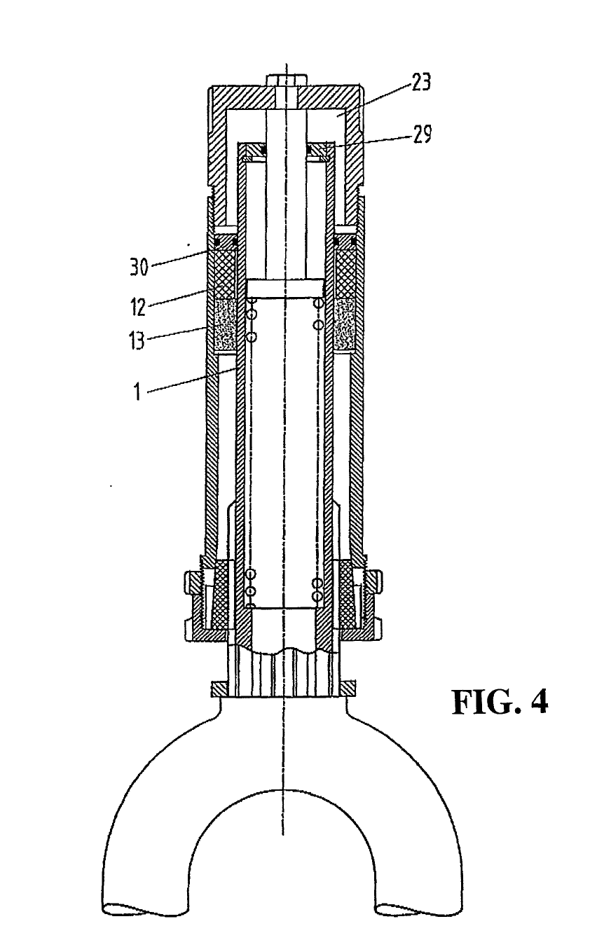

Designated by reference numeral 18 is a guide ring in the upper region of the fork stanchion tube 1. Finally, the area designated by reference numeral 23 is an air space, the effect of which is described in the following with reference to FIG. 4. Reference numeral 21 designates a clamping piece to which the handlebar is mounted. Reference numeral 20 designates the fork formed beneath the fork stanchion tube 1 and in which the wheel is rotatably mounted in a known manner. 19 designates a stop which limits the maximum downward shock absorbing travel of the guide tube 3.

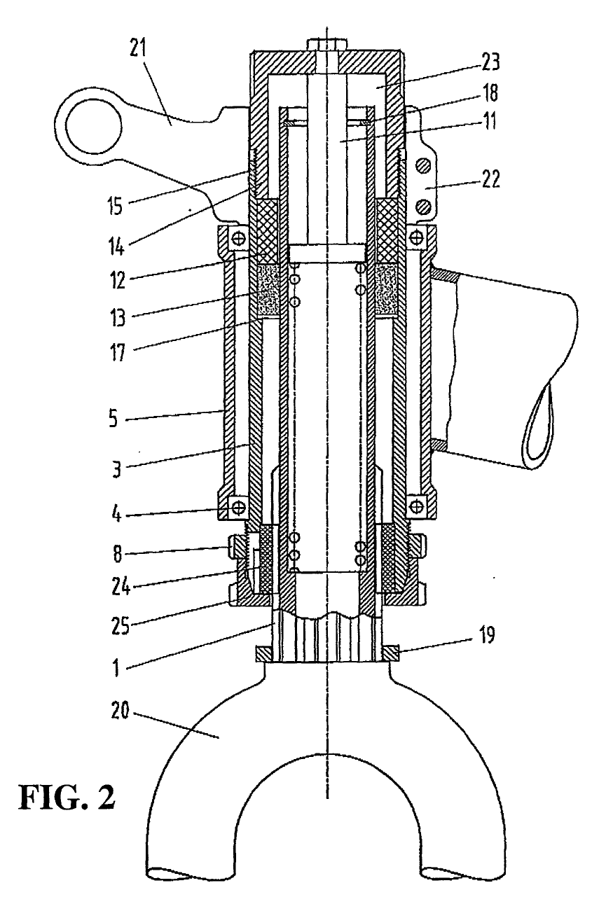

In the embodiment shown in FIG. 2, the previously described region of the shock-absorbing fork in accordance with the invention are configured the same as those in the embodiment of FIG. 1 so that their detailed description will be omitted. However, the embodiment of FIG. 2 differs from the first embodiment by the way in which the play of the bearing bush is readjusted. In the case illustrated in FIG. 2, the guide bush 24 is substantially cylindrical in shape. A radial contraction to reduce the play with the fork stanchion tube 1 is assured in this case by a conical thrust ring 25 having an inner cone acting on the guide tube 3, provided slotted in this case, and compressing this to a greater extent upon movement upwards in FIG. 2 with a screwing movement. The slotted guide tube 3 is thus contracted radially, resulting in radial contraction of the bearing bush 24 so that, also in this case, the play between the bearing bush 24 and the fork stanchion tube can be set and readjusted.

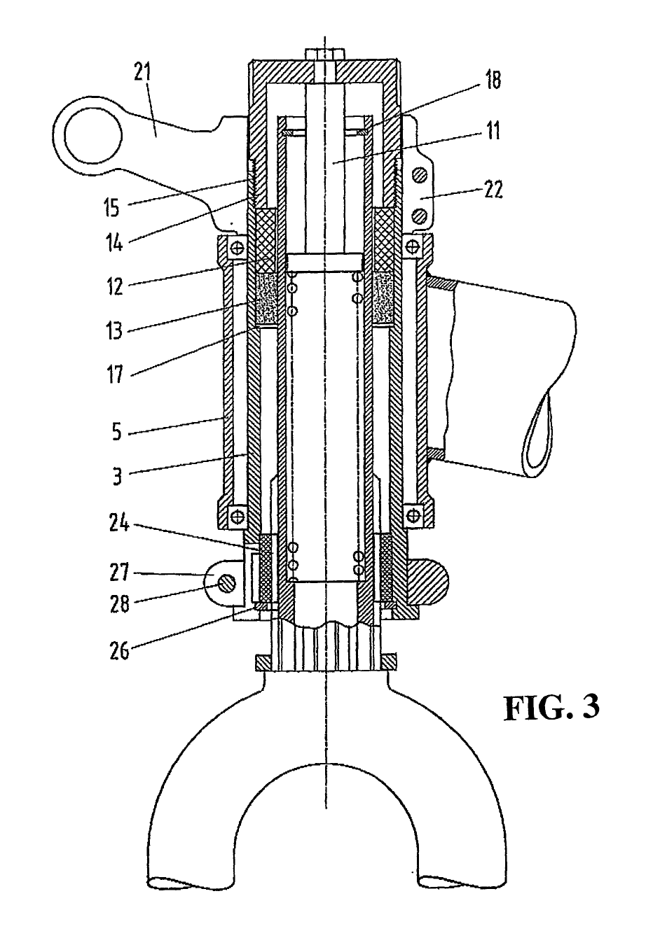

This function is also assured in the third embodiment illustrated in FIG. 3 by, in this case, the diameter of the guide tube 3 being contacted by means of a clamping band or the illustrated, slotted clamping collar 27 with a clamping screw 28. This contraction in the diameter of the guide tube 3 also results in radial contraction of the bearing bush 24, which is substantially cylindrical in the illustrated case, so that also in this embodiment of the invention, readjusting the play is achievable. In the embodiment shown in FIG. 3, the bearing bush 24 is secured against slipping downwards by means of a circlip 26.

Shown in FIG. 4 is a further development of the first embodiment of the invention shown in FIG. 1. In this case, the lower mounting portion of the shock-absorbing fork in accordance with the invention is configured the same as in the embodiment of FIG. 1 so that a corresponding detailed description is omitted. In the embodiment of FIG. 4, the upper region of the shock-absorbing fork in accordance with the invention is modified in the following manner. To the extent that the guide ring 13 is specifically to be used for damping control, it is possible in addition to a mechanical longitudinal biasing to also make use of a supportive pneumatic shock absorption. It is advantageous in this case that slight compression causes only a slight increase in pressure and thus results in small damping forces, whereas heavy compression causes a more substantial increase in pressure in the air cushion and, thus, stronger damping.

The air trapped by the seal 29 and the floating ring piston 30 and compressing within the space 23 upon compression causes the ring piston to press more strongly by means of the bush 12 against the elastic ring 13. This causes a greater retardation of the fork stanchion tube 1 on account of the resulting increased friction. By varying the air volume, the initial pressure and the density and volume of the damping material, a suitable damping characteristic can be produced, resulting in an effect similar to that of a hydraulic damper.

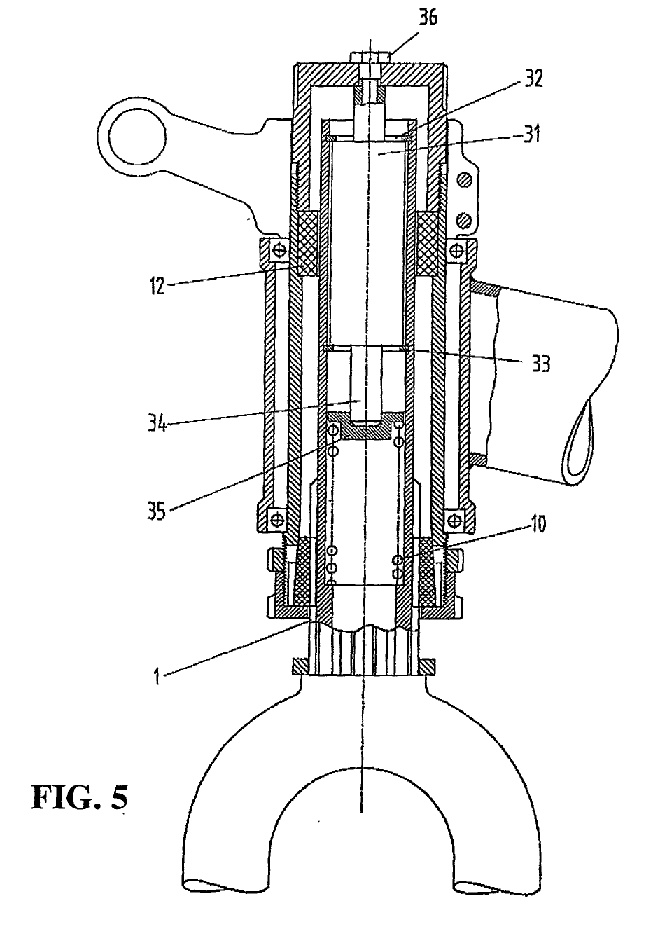

The use of a hydraulic damper is shown in FIG. 5. This results in known means of shock absorbing damping with the advantage that compression and rebound can be damped independently of each other. Furthermore, the damping force increases as a function of the shock intensity. The upper guide, in this case, is handled by a stiff or elastic bush 12. The damper 31 is defined within the fork stanchion tube 1 by means of, for example, Seeger retaining rings 32 and 33. The full-length piston rod 34 presses via a spring plate 35, which also serves as a guide, against the thrust spring to. The upper end of the hollow-bored piston rod 34 acts together with the screw 36 as a tension and compression support for the entire suspension system. In this arrangement, it is possible in principle to provide a damper adjustment (not shown) which can be provided through a hollow piston rod or by means of rotation of the piston rod itself. Also in this embodiment, an advantageous adjustment of the damping characteristics can be achieved and combined with the guidance provided in the lower portion with readjustable play in providing a shock absorbing fork with overall long-term advantageous properties.

1. Shock absorbing fork with a central shock absorbing means accommodatable in the steering head (5) of a two-wheeler frame, a splined or polygonal fork stanchion tube (1) being non-rotatably guided in a correspondingly formed bearing bush (2), the bearing bush (2) itself being mounted non-rotatably in a guide tube (3) rotatably mounted it the steering head (5), characterized in that the bearing bush (2) is elastic and radially contractible and, therefore, the play is variable.

2. Shock absorbing fork according to claim 1, characterized in that the bearing bush (2) is mounted in the guide tube (3) with a conical bearing seat and is axially displaceable by means of a thrust ring (6).

3. Shock absorbing fork according to claim 1, characterized in that the bearing bush (24) is substantially cylindrical and is radially contractible by means of a thrust ring (25) provided with an inner cone, the thrust ring acting preferably on a slotted guide tube (3).

4. Shock absorbing fork according to claim 1, characterized in that the bearing bush (24) is radially contractible by means of a clamping collar (27) or a clamping band which acts preferably on a slotted guide tube (3).

5. Shock absorbing fork according to claim 1, characterized in that an upper guide bearing (12) of the fork stanchion tube (1) is formed or supplemented by an elastic ring (13) which can be axially biased at different loads so that the play and wall friction with regard to the fork stanchion tube (1) are variable.

6. Shock absorbing fork according to claim 5, characterized in that a comparatively rigid bias sleeve (14) acting on the comparatively soft elastic ring (13) is externally adjustable, in particular, by means of a thread (15) and provided with detents so that the desired adjustment can be set and controlled.

7. Shock absorbing fork according to claim 5, characterized in that a supplementary pneumatic shock absorption is provided in the upper guide bearing (12) which influences the biasing of the elastic ring (13).

8. Shock absorbing fork according to claim 6, characterized in that a supplementary pneumatic shock absorption is provided in the upper guide bearing (12) which influences the biasing of the elastic ring (13).

9. Shock absorbing fork according to claim 5, characterized in that a hydraulic oscillation damper is provided in the upper guide bearing (12) in addition to, or instead of, the elastic ring (13).

10. Shock absorbing fork according to claim 6, characterized in that a hydraulic oscillation damper is provided in the upper guide bearing (12) in addition to, or instead of, the elastic ring (13).

11. Shock absorbing fork according to claim 7, characterized in that a hydraulic oscillation damper is provided in the upper guide bearing (12) in addition to, or instead of, the elastic ring (13).

12. Shock absorbing fork according to claim 8, characterized in that a hydraulic oscillation damper is provided in the upper guide bearing (12) in addition to, or instead of, the elastic ring (13).

13. Shock absorbing fork according to claim 1, characterized in that at least one of the partners involved in frictional engagement, the fork stanchion tube (1) and/or the bearing bush (2) is coated with a special friction-reducing coating.

14. Bicycle, motorbike or tricycle comprising a shock absorbing fork according to claim 1.
